(19) United States
(12) Patent Application Publication
(10) Pub. No.: US 2008/0234124 A1
(43) Pub. Date: Sep. 25, 2008

(54) Apparatus and method for steaming treatment of molecular sieves

(75) Inventors: Marcel J. G. Janssen, Kessel-Lo (BE); Cornelius W. M. van Oorschot, Zemst (BE); Sabine Jurachno, Leuven (BE)

Correspondence Address: ExxonMobil Research and Engineering Company, P. O. Box 900, Annandale, NJ, 08801-0900, US

(73) Assignees: ExxonMobil Research; Engineering Company

(21) Appl. No.: 12/077,278

(22) Filed: Mar. 18, 2008

Related U.S. Application Data
(60) Provisional application No. 60/919,029, filed on Mar. 20, 2007.

(51) Int. Cl. B01J 38/06

(52) U.S. Cl. 502/55; 422/122

(57) ABSTRACT

An apparatus for treatment of a plurality of molecular sieves samples is described. The apparatus comprises a steam preparation section, a steam reactor section, and a steam collection section. The steam preparation section includes a steam generator, and a means to supply inert gas into the steam reactor section. The steam reactor section includes a plurality of sample holders. The steam collection section includes a plurality of knock-out vessels. The steam reactor section is operatively connected to the steam preparation section, and the steam collection section is operatively connected to the steam reactor section. In one embodiment, each sample holder is connected and operated in tandem with one knock-out vessel. A process for treating a plurality of molecular sieves samples with steam is also disclosed which may be carried out with the described apparatus.

### CROSS-REFERENCE TO RELATED APPLICATIONS

This Application claims the benefit of U.S. Provisional Application 60/919,029 filed on Mar. 20, 2007, herein incorporated by reference.

### FIELD

Disclosed herein is an apparatus and processes for the automatic and parallel treatment of a plurality of molecular sieves samples.

### BACKGROUND

Combinatorial Chemistry, also known as High Throughput Experimentation (HTE) or high-speed experimentation (HSE), is an emerging area of technology and science that has applicability in various technology fields. It is used in the pharmaceutical industry, as well as in the material science and chemical industries. It is widely recognized that the combinatorial synthesis methods can be a useful tool in increasing the rate of experimentation and improving and accelerating the possibility of making discoveries of new products or processes.

One potential area wherein HTE may be useful relates to the modification and characterization of molecular sieve materials which can serve as catalysts. Molecular sieve materials, both natural and synthetic, are known to have catalytic properties for various types of hydrocarbon conversion. Certain molecular sieve materials are ordered, porous crystalline aluminosilicates (zeolites), aluminophosphates (ALPOs) or silicoaluminophosphates (SAPOs) having a definite crystalline structure as determined by X-ray diffraction, within which there is a large number of smaller cavities which may be interconnected by a number of still smaller channels or pores. These cavities and pores are uniform in size within a specific molecular sieve material. Since the dimensions of these pores are such as to accept for adsorption molecules of certain dimensions while rejecting those of larger dimensions, these materials have come to be known as “molecular sieves” and are utilized in a variety of ways to take advantage of these properties.

Such molecular sieves, both natural and synthetic, include a wide variety of positive ion-containing crystalline aluminosilicates, aluminophosphates and silicoaluminophosphates. These materials can be described as having a rigid three-dimensional framework of SiO₄, and AlO₄, and in some cases PO₄, which form tetrahedra that are cross-linked by the sharing of oxygen atoms whereby the ratio of the total aluminum and silicon and possibly phosphorus atoms to oxygen atoms is 1:2. The electrovalence of the tetrahedra containing aluminum is balanced by the inclusion in the crystal of a cation, e.g., an alkali metal or an alkaline earth metal cation. This can be expressed by the relationship of aluminum to the cations, wherein the ratio of aluminum to the number of various cations, such as Ca/2, Sr/2, Na, K, Cs or Li, is equal to unity. One type of cation may be exchanged either entirely or partially with another type of cation utilizing ion exchange techniques in a conventional manner. By means of such cation exchange, it has been possible to vary the properties of a given molecular sieve by suitable selection of the cation. The spaces between the tetrahedra are occupied by molecules of water prior to dehydration.

It is known that, under certain circumstances, as-synthesized molecular sieves need to be modified to impart to them catalytic activity or improve such catalytic activity. For example, molecular sieves in the organic nitrogen-containing and alkali metal-containing form, the alkaline earth metal form and hydrogen form or another univalent or multivalent cationic form are catalytically-active. The as-synthesized molecular sieves may be conveniently converted into the hydrogen, the univalent or multivalent cationic forms by base exchanging the molecular sieves to remove the alkali metal, such as sodium cations, by such ions as hydrogen (from acids), ammonium, alkylammonium and arylammonium. The hydrogen form of the molecular sieves, useful in such hydrocarbon conversion processes as isomerization of poly-substituted alkyl aromatics and disproportionation of alkyl aromatics is prepared, for example, by base exchanging the sodium form with, e.g., ammonium chloride or hydroxide, whereby the ammonium ion is substituted for the sodium ion. The composition is then calcined, causing evolution of ammonia and retention of the hydrogen proton in the composition.

Molecular sieves can be used as catalysts in combination with a hydrogenating component, such as tungsten, vanadium, molybdenum, rhenium, nickel, cobalt, chromium, manganese, or a noble metal, such as platinum or palladium, where a hydrogenation-dehydrogenation function is desired. Such component can be exchanged into the molecular sieve composition, impregnated therein or physically intimately admixed therewith. The exchange, impregnation or physical admixture can be referred to as “metal loading”. Such component can be impregnated in or onto the molecular sieve, for example, in the case of platinum, by treating the molecular sieve with a solution containing a platinum metal-containing ion. Thus, suitable platinum compounds include chloro-platinic acid, platinous chloride and various compounds containing the platinum tetraamine-platinum complex. Combinations of the aforementioned metals and methods for their introduction can also be used.

Molecular sieves, including zeolites, under some circumstances, are subjected to steaming, usually to modify their properties. For example, Degnan, Jr., U.S. Pat. No. 4,863,885, discloses a method for increasing a hydrocarbon sorption capacity of a zeolite by exposing the zeolite to an aqueous solution having an initial pH of about 10.5 to about 14. According to Degnan, the method is particularly useful for treating steam de-activated zeolites. Degnan suggests steaming the zeolite prior to the treatment of his invention. Kerr, et al., U.S. Pat. No. 3,493,519, describes a method of making hydro-thermally stable catalysts by calcining an ammonium-Y crystalline alumino-silicate in the presence of steam.

Plank et al., U.S. Pat. No. 3,257,310, describe a method for making a cracking catalyst which is activated by treatment with steam. The catalyst may be a crystalline alumino- silicate. Lago et al., U.S. Pat. No. 5,610,112, disclose a method of modifying a catalyst which includes steaming thereof.

Thus, molecular sieves are exposed to steam or hydrothermal environment under various circumstances in commercial use. Hydrothermal or steam stability of such molecular sieves is an important factor in their applicability in various processes. It is important to determine hydrothermal stability of the catalyst, such as the catalyst based on molecular sieves, to determine its applicability in environments which include steam. To determine the hydrothermal stability, often the catalyst is exposed to steam at a certain pressure and temperature, for a particular time period, followed by a performance or other characterization test.

When HTE principles and techniques are used for synthesis of molecular sieves, it may be necessary to provide specially designed apparatus and processes for high throughput modification and characterization of molecular sieves. In so doing, one would look to the suitability of, and the potential need to modify, existing modification and characterization technology.

Several existing approaches have been proposed for HTE-type synthesis, screening and characterization of organic compounds and catalysts, such as homogeneous catalysts. For example, U.S. Pat. No. 6,419,881 proposes a method for the combinatorial syntheses, screening and characterization of libraries of supported and unsupported organometallic compounds and catalysts. U.S. Pat. No. 6,759,014 proposes an apparatus and methods for parallel processing of multiple reaction mixtures. U.S. Patent Application Publication 2003/0100119 proposes combinatorial synthesis and screening of supported organometallic compounds and catalysts. U.S. Patent Application Publication 2004/0132209 suggests a multi-chamber treatment apparatus and method, particularly for a simultaneous treatment of a plurality of materials, such as catalysts.

Notwithstanding these existing approaches, a need nevertheless exists to develop new apparatus and processes for sequential and/or parallel treatment of a plurality of molecular sieve samples, e.g., to determine hydrothermal and/or steam stability thereof.

### SUMMARY

In one aspect, provided is an apparatus for treatment of a plurality of molecular sieves samples which comprises: a steam preparation section, a steam reactor section and a steam collection section. The steam reactor section includes a plurality of sample holders. The steam reactor section is operatively connected to the steam preparation section. The steam collection section includes a plurality of knock-out vessels, and the steam collection section is operatively connected to the steam reactor section. The knock-out vessels may be operatively connected with each respective sample holder. The term “operatively connected”, used in conjunction with sections, elements or components, means that such sections, elements or components are connected to each other through physical means, such as conduits or, mechanically, or through signal means, such as electrical or electronic connections, which may be wired or wireless.

In another aspect, provided is a process for the treatment of a plurality of molecular sieve samples that includes providing an apparatus comprising: a steam preparation section, a steam reactor section, and a steam collection section. The steam reactor section comprises a plurality of sample holders. The steam reactor section is operatively connected to the steam preparation section. The steam collection section includes a plurality of knock-out vessels, which may be operatively connected with each respective sample holder. The process comprises placing the molecular sieves samples into the sample holders, supplying a flow of steam or a mixture of steam and an inert gas into each of the sample holders and removing the steam or the mixture of steam and inert gas from each of the sample holders. The steam or the mixture of steam and inert gas are directed into the plurality of knock-out vessels, where at least a portion of the steam is condensed into a liquid. A desired level of the liquid is maintained in each knock-out vessel during the process.

In yet another aspect, provided is a process for adjusting steam flux (under working pressure) in the apparatus disclosed herein, wherein the sample holders contain molecular sieve samples. The process comprises introducing an inert gas into the steam reactor section and directing the inert gas to all sample holders containing molecular sieve samples. Subsequently, the volumetric flow rate of the inert gas through all sample holders containing the samples is measured, and the volumetric flow rate of the inert gas is adjusted to render the volumetric flow rate substantially equal through each sample holder containing a molecular sieve sample. At that time, the introduction of the inert gas is stopped and steam or a mixture of steam and inert gas is introduced into the steam reactor section.

### BRIEF DESCRIPTION OF THE DRAWINGS

To assist those of ordinary skill in the relevant art in making and using the subject matter hereof, reference is made to the appended drawings, wherein:

FIG. 1 is schematic depiction of an apparatus disclosed herein;

FIG. 2 is schematic depiction of one sample holder with its corresponding knock-out vessel;

FIG. 3A is a perspective view of a single sample holder;

FIG. 3B is a top view of the sample holder of FIG. 3A and its frit bottom-plate sample holder;

FIG. 3C is a top view of a top section of a steaming unit reactor block which includes wells for six sample holders; and

FIG. 3D is a view of the top and bottom sections of the reactor block.

### DETAILED DESCRIPTION

All numerical values herein are understood as modified by adjective “about”.

Disclosed herein is an apparatus and process for efficiently and automatically carrying out parallel treatment of a plurality of molecular sieves. The apparatus and process are directed to high throughput modification and/or characterization of materials, particularly molecular sieves.

The molecular sieves which can be modified and/or characterized include as synthesized molecular sieves, molecular sieves formulated for industrial applications and molecular sieves which are synthesized according to HTE principles. In industrial applications, the molecular sieves are combined with a suitable binder (e.g., alumina) then extruded into a cylindrical or other suitable shape, or in the case of catalytic cracking, the molecular sieve/alumina mixture may be spray dried to produce a 100-250 micron spherical particles.

The steam preparation section comprises a steam generator which supplies steam to the steam reactor section. Properties of the steam may be selected based on a particular application of the apparatus. The steam preparation section also includes two separate means to supply an inert gas, such as nitrogen, helium, or argon or mixtures thereof, a first means to supply an inert gas and a second means to supply an inert gas. Each of the means to supply an inert gas includes a source of the inert gas, such as a storage container for the inert gas or a pipeline carrying the inert gas from a remote location, a Mass Flow Controller (MFC), which controls the rate of flow of the inert gas and suitable conduits and valves.

The first means to supply inert gas is primarily used during a steaming cycle to control steam partial pressure. For example, if it is desired to have a target operating pressure in the apparatus, but steam partial pressure which is lower than the target pressure, the first means to supply inert gas introduces an appropriate amount of the inert gas into the system to achieve the desired steam partial pressure.

The second means to supply an inert gas is primarily used during a pre-heat cycle (also referred to herein as “heat-up cycle”) to preheat the apparatus in an inert gas atmosphere to a desired temperature prior to the commencement of the steaming cycle. The first means to supply inert gas may also be used for that purpose, if it is desired to conduct the heat-up cycle in the atmosphere of diluted steam. Alternatively, the first means to supply inert gas may be used in the heat-up cycle to preheat the apparatus in an inert atmosphere to a temperature higher than steam condensation temperature. At that point, steam is introduced to complete the heat-up cycle. The first means to supply inert gas is connected by appropriate valves, if needed, and conduits to a first three-way valve of the steam preparation section, which is also connected to a conduit from the steam generator. One outlet of the first three-way valve is connected to a supply conduit which delivers steam to a manifold of the steam reactor section. The first three-way valve can control the flow of steam, or a mixture of steam and inert gas, through the supply conduit into the manifold either during the heat-up cycle or during the steaming cycle.

The second means to supply inert gas is connected to a second three-way valve of the steam preparation section which can direct the inert gas into the supply conduit. The second three-way valve can direct substantially pure inert gas into the manifold and thus it is primarily used to conduct the heat-up cycle in a substantially pure inert gas atmosphere.

The steam preparation section also includes a first back pressure controller (BPC) which controls, in a known manner, the steam partial pressure. The first BPC is used for calibrating and stabilizing the steam flow.

The steam preparation section includes suitable conduits, a shut-down valve and pressure indicators (PI). The first BPC is connected to the first and second means to supply inert gas through suitable conduits and valves.

The steam reactor section comprises a suitable enclosure with a means to control temperature of the enclosure. The enclosure contains the plurality of sample holders. (The sample holders may also be referred to herein as “reactors”). The enclosure may be, for example, an oven or a furnace, such as a muffle furnace. The enclosure may have any conventional construction. The means to control the temperature may include any conventional device, or devices, such as a thermostat and a heater. The sample holders are placed inside the enclosure in any conventional manner. Each of the sample holders is connected to the manifold through an inlet conduit, usually connected to the sample holders at one end thereof, and to a knock-out port (also referred to herein as a “knock-out vessel”) through an outlet conduit, usually connected to the sample holders at the end opposite than the inlet conduit. The sample holders may have any suitable construction and size. In one embodiment, the multiplicity of sample holders is placed in a reactor block having a substantially circular cross-section and the reactor block is placed into the enclosure. The reactor block comprises a bottom and a top section. The bottom section comprises a multiplicity of wells, each having an opening at the bottom which is connected to the outlet conduit. The sample holders are inserted into the wells. The bottom of each sample holder may have a frit insert, formed from a porous metal plate. The frit insert supports the molecular sieve sample and it is permeable to gases or vapors, such as nitrogen and steam. Instead of the porous metal frit insert, the sample holders may have a porous frit made out of porous glass or porous ceramics. The sample holders may contain powdered molecular sieves, or pelletized and crushed or formulated molecular sieves with a particle size of 25 to 500 μm. The upper section of the reactor block includes a plate having the same size and circular cross-section as the bottom section. The upper section includes a fluid distribution manifold which distributes gases (steam, inert gas or a combination thereof) to each of the sample holders.

The steam collection section includes a plurality of knock-out vessels. In one embodiment, the steam collection section includes one knock-out vessel for each sample holder. Each knock-out vessel is connected to the respective sample holder via the outlet conduit.

Each knock-out vessel includes a first knock-out vessel valve (usually placed at the upper section of the vessel) which controls the flow of gases from the knock-out vessel. A second knock-out vessel valve (usually placed at the lower section of the vessel) controls the flow of liquids from the vessel. A means to control and maintain a desired level of liquid is included in each knock-out vessel. Such means comprises, in one embodiment, a high level controller (HLC) and a low level controller (LLC). Each of these controllers is connected to the second knock-out vessel valve. Each of the controllers may comprise an extra sensitive conductivity sensor which detects the liquid (i.e., condensate) level in the vessel. When the liquid reaches a pre-set level of the HLC conductivity sensor, the HLC sends a signal to the second knock-out vessel valve to open and drain the liquid. When the liquid reaches a pre-set level of the LLC conductivity sensor, the LLC sends a signal to the second knock-out vessel valve to close it. The operation of the HLC and LLC maintains the desired liquid level in each knock-out vessel.

The liquid drained from the knock-out vessel may be directed to a main drain conduit. Alternatively, the amount of liquid condensed within a given time interval may be measured by collecting the condensate in a suitable vessel and measuring the condensate volume produced in the time interval.

The steam collection section also includes a means to maintain a desired pressure, in the steam reactor section, the steam collection section and the entire apparatus, which may otherwise be reduced to undesirably low levels by condensation of gases, such as steam. The pressure is maintained by a means to introduce supplemental gas into the steam collection section. Such means includes a source of a supplemental gas, a third MFC which controls the flow of the supplemental gas, a second BPC and a main vent header, connected to the third MFC and the second BPC. The main vent header is connected via suitable conduits to each of the knock-out vessels. The supplemental gas may be an inert gas, such as nitrogen, helium, argon or mixtures thereof or air. If condensation of steam results in a reduction of the steam volume, the means to introduce a supplemental gas is used to compensate for the volume reduction. Otherwise, continued reduction in volume, unchecked, over time may create an undesirably low pressure in the apparatus.

Thus, the means to introduce supplemental gas maintains a substantially constant pressure throughout the apparatus even if significant steam condensation takes place. The second BPC is set to maintain a certain, desired system pressure. During operation of the apparatus, steam condensation is likely to occur. If condensation is such that it causes the pressure in the system to decrease below the set pressure, the second BPC and the third MFC will cause the bleeding of the supplemental gas into the main vent header, and consequently into the knock-out vessel or vessels in which such steam condensation occurred that caused the undesirably low pressure. The bleeding will continue until the set, desired pressure is restored. The connection between the conduits (connecting the main vent header to each of the knock-out vessels) may be through the first knock-out vessel valve. Further, an additional three way valve (for each knock-out vessel) may be interposed between the conduits and the first knock-out vessel valves. The supplemental gas can be directed into individual knock out vessels, on as needed basis, or it can be directed to all knock-out vessels substantially simultaneously, as determined by the amount of condensation in the knock-out vessel or vessels. The additional three way valve may be used to direct gasses from the knock-out vessel either to an individual reactor vent (associated with each knock-out vessel) or to the main vent header.

As discussed above, the first knock-out vessel valve (which may be a needle valve) may be connected to the additional three way valve. If the additional three way valve directs the gases from the knock-out vessel to a separate reactor vent, the vent can be used for e.g., flow calibration and stabilization (also referred to herein as “calibration”). The term “flow calibration and stabilization” is defined as the procedure for measuring and/or setting the steam flux through each of the sample holders.

The apparatus also includes a means to pre-heat the apparatus (if desired), and measure and/or set the steam flux through each of the sample holders (i.e., sample compartments). The term “steam flux” means the rate of volumetric flow of steam or a mixture of steam and an inert gas per unit of time. Due to packing differences in individual sample holders, pressure drop over individual samples of molecular sieves in each sample holder may be somewhat different. The apparatus has a means to compensate for such differences. The approximate value of steam flux can be set by calibrating the apparatus during the pre-heat cycle. To set the required steam flux, the sample holders are filled with molecular sieve samples. The first knock-out vessel valve of the knock-out reactor in the steam collection section is opened (and of course, any other valves to which the first valve knock-out vessel valve is connected are opened). In the pre-heat cycle, an inert gas, such as nitrogen, is conducted at the desired pressure through the entire apparatus, by directing the inert gas from the second means to supply inert gas into the steam reactor section and, subsequently, into the steam collection section. Accordingly, the volumetric flow rate of inert gas can be measured at the first knock-out vessel valve (or any conduit, valve or vent connected to the first knock-out vessel valve) of the steam collection section. The rate of flow of inert gas through the first knock-out vessel valve is adjusted to substantially equally distribute the total inert gas flow over all sample holders. As a result, the inert gas flow (i.e., volumetric flow rate of the inert gas) is substantially equally distributed through all sample holders. This allows one to compensate for small differences in pressure drop due, for example, to packing differences. The volumetric flow rate through each sample holder can be determined in any conventional manner, such as, a conventional gas flow meter or alternatively with a wet gas meter or soap bubble meter. Thus, for example, if a total flow rate of nitrogen into the manifold of the steam reactor section is a 300 cc per minute, the first knock-out vessel valve can be adjusted so that volumetric flow rate of nitrogen through each of the sample holders would be approximately 50 cc per minute. In one embodiment, the volumetric flow rate of the inert gas for each sample holder is measured at a separate vent connected to the first knock-out vessel valve during the pre-heat cycle.

Once the volumetric flow rate of inert gas is adjusted to the desired level, and the desired operating temperature is reached, the flow of the steam or a mixture of steam and an inert gas is commenced. The volumetric flow rate of steam or the mixture of steam and inert gas through each of the sample holders will be approximately the same as that calibrated for the pure inert gas flow during the pre-heat stage.

In all embodiments, the operation of the entire apparatus, including the steam preparation section, the steam reactor section and the steam collection section, and any individual components or groups of components of the apparatus, may be controlled automatically by a conventional programmable device, such as a computer, semi automatically or in any other suitable manner.

One exemplary embodiment of the apparatus and process of treating molecular sieves samples in the apparatus is discussed below in Example 1. This example is presented for illustrative purposes only, and it does not limit the scope of this disclosure, which is defined by the entire specification and claims.

### EXAMPLES

### Example 1

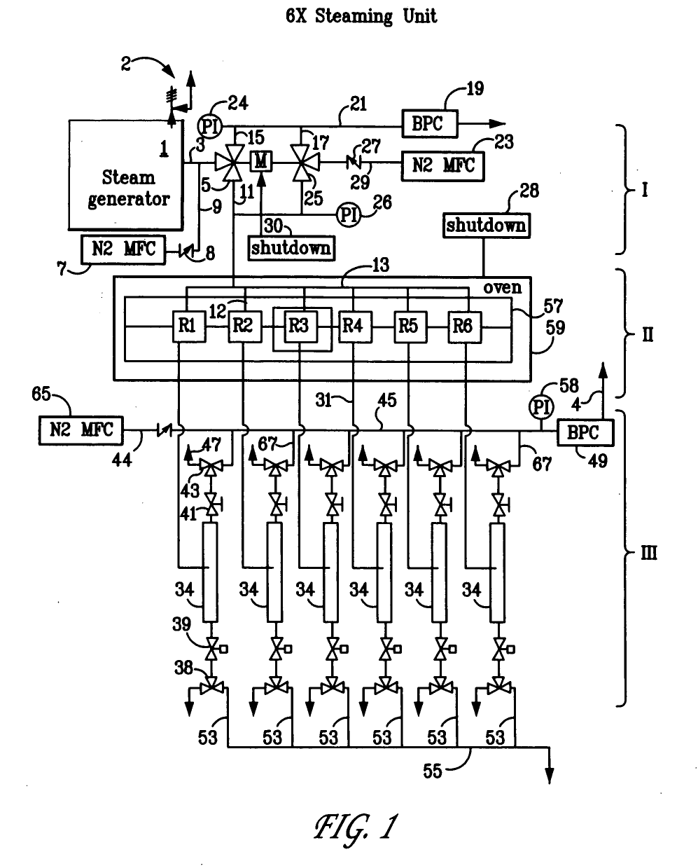

This example is described with reference to FIGS. 1-3. As shown in FIG. 1, the apparatus includes a steam preparation section I, a steam reactor section II and a steam collection section III (also referred to herein as “Section I, Section II and Section III”, respectively).

The steam preparation section includes a steam generator 1, which can be any suitable steam generator for a particular application. As will be apparent to those skilled in the art, a steam generator will be selected based on its ability to generate the desired steam flux and steam having the desired properties, such as pressure and temperature. The steam generator includes a safety relief valve 2. Steam generated by the steam generator is conducted by a conduit 3 to a first three-way valve 5 of Section I. The steam preparation section also includes a first means to supply an inert gas 7 to a first three-way valve 5. The first means to supply the inert gas 7 includes a source of an inert gas (not shown) and a mass flow controller (MFC). The source of inert gas may be any means to supply such gas, e.g., a suitable storage vessel with a pump, or a gas line conducting the inert gas from a remote location. The first means to supply the inert gas also includes a conduit 9 and a check-valve 8. The three-way valves 5 and 25 enable the operator to direct steam, inert gas, or a mixture thereof into a supply conduit 11 which delivers the gas or gases into a manifold 13 of the steam reactor section. The inert gas may be any suitable inert gas, such as nitrogen, helium, argon or mixtures thereof. The steam preparation section includes a back-pressure controller (BPC) 19, which controls the steam partial pressure during the steam calibration and stabilization. The steam preparation section further includes a second means to supply an inert gas 23, which also includes any suitable supply of inert gas (not shown) and a second MFC. The second means to supply inert gas 23 is connected through a conduit 29 and a check-valve 27 to a second three-way valve 25 of Section I.

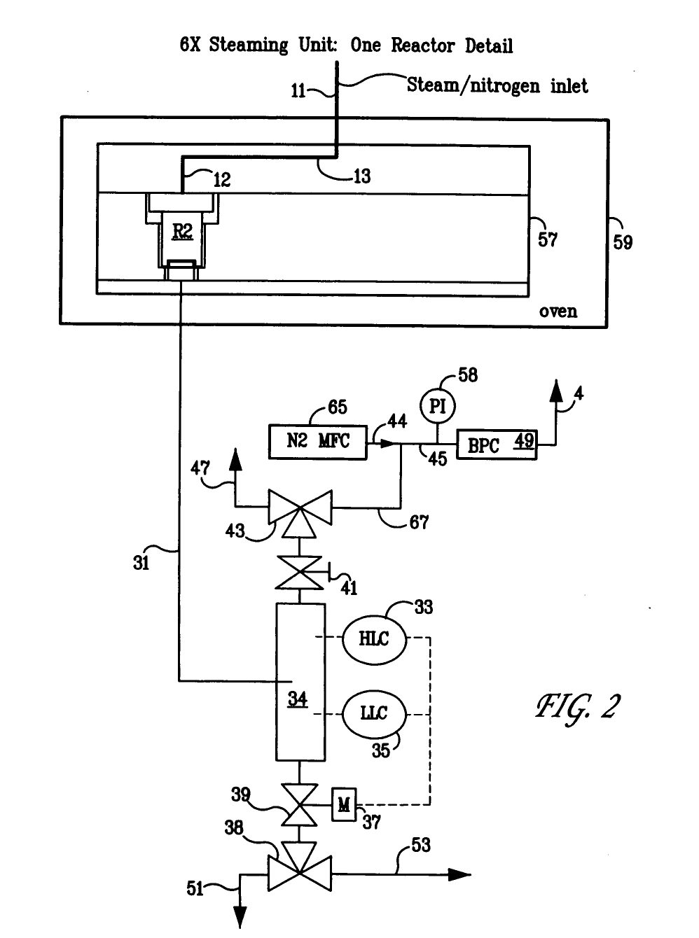

As shown in FIG. 1, the steam collection section includes a plurality of knock-out reactors 34. FIG. 2 illustrates details of one such knock-out reactor. The operation of a steaming cycle of the sample holders and their respective knock-out vessels will be described in connection with one sample holder and its respective knock-out reactor (or vessel). Other sample holders and knock-out vessels are operated in substantially the same manner.

The steam reactor section comprises an oven 59, which contains a manifold 13 and a reactor block 57. The reactor block includes a number of sample holders R1-R6. Each of the sample holders is connected by an inlet conduit 12 to the manifold 13 and by an outlet conduit 31 to a respective knock-out vessel 34.

Each knock-out vessel includes a high-level controller 33, a low level controller 35, and a signal receiving means 37, such as a solenoid, connected to the second knock-out vessel valve 39, which controls the flow of liquids from the knock-out vessel. High and low level controllers 33 and 35 may include extra sensitive conductivity sensors to detect high or low level of liquid. Such sensors are exemplified by Endress+Hauser Type 11371-121 with a length of 150 mm, serial number 7800400103D. The knock-out vessel also includes a first knock-out vessel valve, 41, which is a needle valve, which controls the flow of gases from the knock-out vessel. The first knock-out vessel valve is connected to a three-way valve 43, which directs gases to the main vent header 45 or to a separate reactor vent 47. The steam collection section also includes a back pressure controller 49 which controls the total operating pressure for the total steam operation of the apparatus. Conduit 4 is a vent line which may be used to vent gases to the atmosphere. The level of liquid in the knock-out vessel is controlled by the high-level controller and the low-level controller. In operation, the steam exiting the reactor block through the outlet conduit 31 enters the knock-out vessel, in which it condenses. The condensate includes liquid water. The knock-out vessel gradually fills up with the liquid until the liquid reaches the pre-set level of the high level controller. At that time, an electrical signal is sent to the valve 39 via a solenoid 37, which causes the opening of valve 39, and the knock-out vessel is drained to remove the liquid through conduits 51 or 53.

Conversely, if the liquid level reaches the pre-set level of the lower level controller, the electrical signal is sent to the valve 39, whereupon the valve 39 is closed. Then the liquid can again fill up the vessel until the liquid level reaches the pre-set level of the high-level controller 33.

The three-way valve 38 enables one to collect the condensate and measure the amount of liquid condensed per unit of time. This can be done, e.g., by controlling the valve 38, so that it will direct the condensate to a conduit 51 (FIG. 2), and collecting the condensate within a given time period.

Conversely, the condensate may be directed to a conduit 53 which will, in turn, direct it to a main drain conduit (also referred to herein as a “central collecting line”) 55, (FIG. 1), from which the condensate may be discarded in a suitable manner or collected in a central location.

The apparatus also includes the means to measure and/or set under working pressure an approximate steam flux through each of the sample holders (i.e., sample compartments.) The approximate steam flux can be determined during the pre-heat cycle. This cycle will be described as conducted with nitrogen, but any other inert gas may be used. The nitrogen used for calibration and stabilization of the steam flux during the pre-heat cycle is supplied by the second means to supply inert gas 23, if substantially pure nitrogen is used in that cycle. To measure and/or set the steam flux, the sample holders are filled with molecular sieve samples. The first knock-out vessel valve 39 is opened (and of course, valve 43 is opened). In the pre-heat cycle, nitrogen is conducted through the entire system, as discussed above. Accordingly, the flow of nitrogen can be measured at conduit 47. The rate of flow of nitrogen through the valve 41 can be regulated to substantially equally distribute the total nitrogen flow over all sample holders by adjusting opening of the valve. This allows one to compensate for small differences in pressure drop due, for example, to packing differences in the sample holders. The volumetric flow rate of nitrogen through each sample holder can be determined in any conventional manner, such as a conventional gas flow meter or alternatively with a wet gas meter or soap bubble meter.

Thus, for example, if total flow rate of nitrogen into the manifold 13 is 300 cc per minute, valve 41 can be adjusted so that volumetric flow rate of nitrogen through each of the sample holders is approximately 50 cc per minute for the apparatus comprising six sample holders R1-R6. Once the volumetric flow rate of nitrogen is adjusted to the desired level, and the desired operating temperature is reached, the flow of steam or a mixture of steam and nitrogen is commenced. The volumetric flow rate of steam (or the steam/nitrogen mixture) through each of the sample holders will be approximately the same as that calibrated for the pure nitrogen flow during the pre-heat stage (also referred to herein as “pre-heat cycle”). The temperature of steam or a mixture of steam and nitrogen, flux thereof and any other properties are adjusted to a desired level for a particular type of molecular sieves. The steam or the mixture of steam and nitrogen are conducted through the steam reactor section for the time necessary to provide sufficient exposure of the molecular sieves needed to determine hydro-thermal or steam stability thereof, or to achieve a desired modification of the molecular sieves properties. The steam or a mixture of steam and inert gas is conducted into the steam reactor section II through the conduit 3, the valve 5, the conduit 11, and the manifold 13. In the steam reactor section, the steam (or a mixture of steam and inert gas) is distributed substantially equally to each of the sample holders R1-R6. The steam or the steam and inert gas then exit the sample holders through conduits 31 and is directed to individual knock-out vessels 34. In the knock-out vessels 34, the steam is at least partially condensed, with liquid accumulating at the bottom of each knock-out vessel, and gases exiting the knock-out vessel through the valves 41 and 43. The gases then proceed either to an individual reactor vent 47 or to the main vent header 45 through a conduit 67. If needed, inert gas, such as nitrogen, is supplied to the main header 45 by a means 65 to introduce a supplemental gas, as discussed below.

The steam collection section also includes the means 65 to introduce a supplemental gas into that section. The means 65 includes a source of the supplemental gas (not illustrated), such as an inert gas, e.g., nitrogen or helium, a mass flow controller and a back pressure controller 49. The BPC 49 is set to maintain a certain, desired system pressure. If condensation of steam results in a reduction in volume thereof, the means to introduce a supplemental gas is used to compensate for the volume reduction. Otherwise, continued reduction in volume, unchecked, over time may create an undesirably low pressure in the apparatus. Thus, the means to introduce supplemental gas maintains a substantially constant pressure throughout the apparatus even if significant steam condensation takes place.

The operation of the means 65 to introduce supplemental gas, the back pressure controller 49 and the pre-heat cycle with nitrogen (or another inert gas), including the calibration, may be controlled automatically by a conventional programmable device, such as a computer, semi automatically or in any other suitable manner. Since, during operation of the apparatus, liquid condensation is likely to occur, there will almost always be some bleeding of the supplemental gas into the main vent header 45 and from it through a conduit 44 into one or more of the knock-out vessels 34. The bleeding is controlled by the BPC 49 and the mass flow controller, included in the means 65. The supplemental gas is conducted into at least one of the knock-out vessels 34 through the conduit 44, the main vent header 45, a conduit 67 and the three-way valve 43. The supplemental gas can be directed into individual knock-out vessels, on as needed basis, or it can be directed to all knock-out vessels substantially simultaneously, as determined by the amount of condensation in the knock-out vessel or vessels. The supplemental gas is directed into the main vent header and the knock-out vessels until the set pressure of the BPC is restored.

The back pressure controller 49 controls the total working pressure of the steam reactor section and it can be adjusted so that the desired pressure in each of the reactors R1-R6 is maintained. As shown in FIG. 2, the second BPC 49 includes a pressure indicator 58. High level controller 33 and low level controller 35 are necessary to maintain pressure in the apparatus. To maintain this pressure, certain amount of liquid needs to be present in the knock-out vessel 34; otherwise, the system would be at risk of losing pressure.

Pressure indicators 24, 26 and 58 provide pressure readings at respective portions of the apparatus. Shutdown elements 28 and 30 provide a means to terminate the operation of respective portions of the apparatus. The operation of the steam generator, mass flow controllers 7, 23 and 65 and back pressure controller 19, as well as the entire operation of the apparatus may be controlled by a suitable programmable device, such as a computer, semi-automatically or in any other suitable manner.

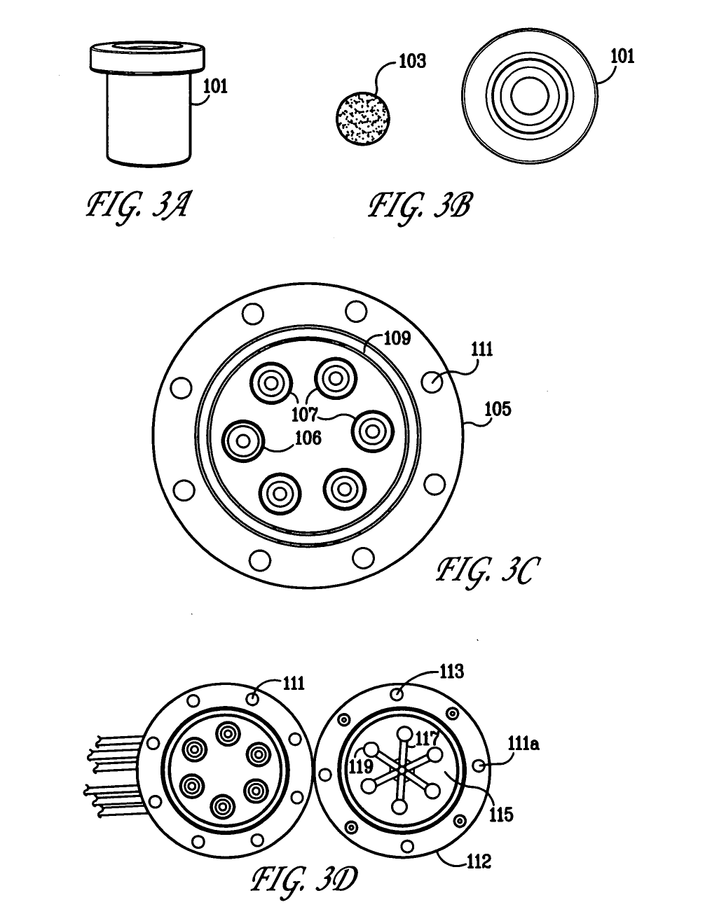

FIGS. 3A-3D illustrate a sample holder and the reactor block exemplified in FIGS. 1 and 2. FIG. 3A is a side perspective view of a sample holder 101, which has the height of about 15 mm and an internal diameter of about 10 mm. FIG. 3B is a top view of the sample holder of FIG. 3A. Element 103 is a bottom-plate which is inserted at the bottom of the sample holder, and is made of a metal frit, which can be made of stainless steel.

The bottom plate may have a diameter of ⅜″ and a thickness of 1 mm. FIG. 3C shows a bottom section 105 of the reactor block 57. It also shows that five of the six wells 107 contain sample holders, while the sixth well 106 is vacant. A copper-ceramic washer 109 is inserted to provide a tight fit with a top section 112 (also referred to herein as “top portion”) of the reactor block, when the reactor block is assembled to be inserted into the apparatus of FIGS. 1 and 2.

The top section 112 of the reactor block is illustrated in FIG. 3D. That portion includes a manifold 115 which comprises six arms 117, each terminated into an opening 119. Steam, inert gas, or a mixture of steam and inert gas is introduced into the manifold 117, and then is carried by each of the arms 117 through openings 119 into each of the sample holders 101. Openings 111 in the bottom section of the reactor correspond to openings 111a in the top section. When the top section is placed on top of the bottom section, the two sections can be fastened together, e.g., by bolts inserted through the openings 111 and 111a. The sample holders 101 have the capacity to hold approximately 500 mg of molecular sieves samples per sample holder.

The reactor block may have any suitable construction and shape, such as rectangular, square, or elliptical. The reactor block may also comprise any suitable number of wells for the sample holders, such as 5-20, 5-15, or 6-12 wells.

Various parts of the apparatus disclosed herein are made from materials suitable for a particular application, which is controlled by the conditions of operation required by such application, such as temperature and pressure. Thus, in one embodiment, the steaming unit reactor block is made from stainless steel, the steam generator is model VEIT2365/2 available from, Logifin Solutions BVBA Belgium, the oven is model MOD495, available from Fisher. Various operational components of the apparatus, such as mass flow controllers and back pressure controllers are conventional and known in the art.

For all embodiments wherein an inert gas is used, the inert gas may be nitrogen, helium, argon or a mixture thereof. Conversely, if a particular inert gas, e.g., nitrogen, is specified, it may be substituted by any other suitable inert gas.

All patents, test procedures, and other documents cited herein, including priority documents, are fully incorporated by reference to the extent such disclosure is not inconsistent with the disclosure herein and for all jurisdictions in which such incorporation is permitted. When numerical lower limits and numerical upper limits are listed herein, ranges and individual values from any lower limit to any upper limit are contemplated.

Applicants have attempted to disclose all embodiments and applications of the disclosed subject matter that could be reasonably foreseen. However, there may be unforeseeable, insubstantial modifications that remain as equivalents. While the present disclosure has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description and examples

While the illustrative forms have been described with particularity, it will be understood that various other modifications will be apparent to and can be readily made by those skilled in the art without departing from the spirit and scope of applicants' disclosure. Accordingly, it is not intended that the scope of the claims appended hereto be limited to the examples and descriptions set forth herein but rather that the claims be construed as encompassing all the features of patentable novelty, including all features which would be treated as equivalents thereof by those skilled in the relevant art.

What is claimed is:

1. An apparatus for treatment of a plurality of molecular sieves samples comprising:
(a) a steam preparation section;
(b) a steam reactor section, including a plurality of sample holders, the steam reactor section operatively connected to the steam preparation section; and
(c) a steam collection section operatively connected to the steam reactor section, the steam collection section including a plurality of knock-out vessels.

2. The apparatus of claim 1 wherein the steam preparation section includes:
(a) a steam generator;
(b) a conduit for delivering steam to a manifold of the steam reactor section;
(c) a first means to supply an inert gas into the manifold;
(d) a second means to supply an inert gas into the manifold;
(e) a means to control the flow of steam into the manifold.; and
(f) a means to control the flow of the inert gas into the manifold.

3. The apparatus of claim 1, wherein the steam preparation section further includes a first back pressure controller (BPC).

4. The apparatus of claim 3, wherein a first BPC controls the steam partial pressure during calibration and stabilization.

5. The apparatus of claim 2, wherein the first means to supply an inert gas includes a source of an inert gas and a first Mass Flow Controller (MFC).

6. The apparatus of claim 2, wherein the second means to supply an inert gas includes a source of an inert gas and second Mass Flow Controller (MFC).

7. The apparatus of claim 2, wherein the manifold in the steam reactor section has connected thereto a plurality of inlet conduits, each inlet conduit connecting the manifold to a respective sample holder.

8. The apparatus of claim 1, wherein the reactor section includes a reactor block which contains the plurality of sample holders.

9. The apparatus of claim 8, wherein the reactor block is substantially—circular in cross-section.

10. The apparatus of claim 1, wherein the steam reactor section comprises an enclosure including a means to control temperature of the enclosure, the enclosure containing the plurality of sample holders.

11. The apparatus of claim 5, wherein the enclosure is an oven or a muffle furnace.

12. The apparatus of claim 1, wherein the steam reactor section includes a plurality of outlet conduits, each outlet conduit connecting each of the sample holders to a respective knock-out vessel.

13. The apparatus of claim 1, wherein the steam collection section includes a means to introduce a supplemental gas into the main vent header

14. The apparatus of claim 13, wherein the means to introduce a supplemental gas includes a third MFC which controls flow of the supplemental gas into the main vent header.

15. The apparatus of claim 14 which comprises a means to conduct the supplemental gas from the main vent header to at least one knock-out vessel.

16. The apparatus of claim 13, wherein the means to introduce a supplemental gas into the main vent header includes a second BPC.

17. The apparatus of claim 16, wherein the second BPC controls total operating pressure in the apparatus.

18. The apparatus of claim 13, wherein the means to introduce a supplemental gas includes a source of an inert gas, connected to the main vent header, the main vent header operatively connected to each knock-out vessel.

19. The apparatus of claim 16, wherein the second BPC is operatively connected to the main vent header.

20. The apparatus of claim 1, wherein each knock-out vessel comprises a means to maintain a desired level of liquid in the knock-out vessel.

21. The apparatus of claim 20, wherein each knock-out vessel comprises a first knock-out vessel valve controlling the flow of gases from the knock-out vessel, and a second knock-out vessel valve controlling the flow of liquids from the knock-out vessel.

22. The apparatus of claim 21, wherein the means to maintain a desired level of liquid includes a high level controller, operatively connected to a means for operating the second knock-out vessel valve, and a low level controller, operatively connected to a means for operating the second knock-out vessel valve.

23. The apparatus of claim 22, wherein the second knock-out vessel valve is connected to a third valve, located in the steam collection section, which is operable to direct the liquids into a main drain conduit or to collect the liquids within a selected time period for at least one sample holder.

24. A process for the treatment of a plurality of molecular sieves samples, including
(a) providing an apparatus comprising:
(i) a steam preparation section;
(ii) a steam reactor section, including a plurality of sample holders, the steam reactor section operatively connected to the steam preparation section; and
(iii) a steam collection section operatively connected to the steam reactor section, the steam collection section including a plurality of knock-out vessels operatively connected with each respective sample holder;
(b) placing said molecular sieves samples into said sample holders;
(c) supplying a flow of steam or a mixture of steam and an inert gas into each of the sample holders;
(d) removing the steam or the mixture of steam and inert gas from each of the sample holders and directing the steam or the mixture of steam and inert gas into the plurality of knock-out vessels;
(e) condensing at least a portion of the steam into a liquid; and
(f) maintaining a desired level of the liquid in each knock-out vessel.

25. The process of claim 24, wherein the steam or the mixture of steam and inert gas is removed from at least one of the sample holders and is directed into a knock-out vessel associated with the respective sample holder through an outlet conduit.

26. The process of claim 24, wherein a supplemental gas is introduced into the main vent header.

27. The process of claim 26, wherein the supplemental gas is conducted from the main vent header into at least one knock-out vessel, as needed to maintain pressure in the at least one knock-out vessel.

28. The process of claim 26, wherein the supplemental gas is an inert gas.

29. A process for adjusting steam flux under working pressure in the apparatus of claim 1, comprising:
(a) introducing an inert gas into the steam reactor section;
(b) directing the inert gas to all sample holders containing molecular sieve samples;
(c) measuring the volumetric flow rate of the inert gas through each sample holder;
(d) adjusting the volumetric flow rate of the inert gas to render the volumetric flow rate substantially equal through each sample holder containing a molecular sieve sample;
(e) terminating the introduction of the inert gas; and
(f) introducing steam or a mixture of steam and inert gas into the steam reactor section.

30. The process of claim 29, wherein the volumetric flow rate of the inert gas is adjusted by varying the opening of a first knock-out vessel valve in each knock-out vessel controlling the flow of gases from the knock-out vessel, while maintaining in closed position a second knock-out vessel valve controlling the flow of liquids from each knock-out vessel.
